(19) United States
(12) Patent Application Publication
(10) Pub. No.: US 2023/0064837 A1
(43) Pub. Date: Mar. 2, 2023

(54) LEARNING-BASED METHOD FOR ESTIMATING SELF-MOVEMENT AND DISTANCE INFORMATION IN A CAMERA SYSTEM HAVING AT LEAST TWO CAMERAS USING A DEEP LEARNING SYSTEM

(71) Applicant: Robert Bosch GmbH, Stuttgart (DE)

(72) Inventors: Oliver Lange, Hemmingen (DE); Beke Junge, Hildesheim (DE); Matthias Kirschner, Hildesheim (DE)

(21) Appl. No.: 17/841,132

(22) Filed: Jun. 15, 2022

(30) Foreign Application Priority Data
Aug. 25, 2021 (DE) 10 2021 209 294.2

(51) Int. Cl. G06T 7/292; G06T 7/579; G06T 7/80

(52) U.S. Cl. CPC G06T 7/292; G06T 7/579; G06T 7/80; G06T 2207/20081; G06T 2207/30244

(57) ABSTRACT

A learning-based method for estimating self-movement and items of distance information in a camera system having at least two cameras, according to which temporally successive individual images produced by each camera during the movement of the camera system are supplied as input images to a self-monitored deep neural network of a deep learning system. According to the method, the self-monitored neural network is trained using these individual images. Moreover, in the course of the inference the deep learning system produces, from the input images, output data that describe the movement of the camera system.

### CROSS REFERENCE

The present application claims the benefit under 35 U.S.C. § 119 of German Patent Application No. DE 10 2021 209 294.2 filed on Aug. 25, 2021, which is expressly incorporated herein by reference in its entirety.

### FIELD

The present invention relates to a learning-based method for estimating self-movement and distance information in a camera system having at least two cameras, using a deep learning system. The present invention also relates to such a camera system that is movable and that is set up/programmed to carry out this method.

### BACKGROUND INFORMATION

In the area of camera-based environment acquisition using deep learning methods, for some time there has been an observable tendency to use so-called self-monitored or non-monitored learning methods that require little to no additional training data in the form of manual annotations or a reference sensor system, for example for determining the depth or the camera movement. Correspondingly, in the following networks trained in self-monitored fashion are also referred to for short as self-monitored networks.

In conventional deep learning methods, the self-monitoring is based on geometrically transforming an initial image, recorded by a camera, into a target image, and subsequently calculating a photometric error between the initial image and the target image. The associated geometric transformation, towards which a pixel of the initial image moves in the target image, here results directly from the outputs of the deep learning system, such as the optical flux or the depth of the associated 3D point and its movement. Here the transformation takes place in such a way that the photometric error between the transformed initial image and the target image becomes as small as possible.

In general, deep learning methods, compared to their classical counterparts, provide better performance, in the sense of smaller errors and higher density.

### SUMMARY

An object of the present invention is to provide new paths in the development of deep learning methods for camera systems.

This object may be achieved by the subject matter of the present invention. Preferred specific embodiments of the present invention are disclosed herein.

Accordingly, a basic feature of the present invention is to estimate the movement of a camera system having at least two cameras through the use of a deep learning system that has at least one deep neural network. Here, individual images recorded by the cameras are supplied to the (preferably self-monitored) neural network as input images. For each camera that is present, at least two temporally successive individual images have to be provided to the deep learning system in each case.

Through the use of at least two cameras, it is possible for the deep learning system to exploit geometric multi-camera conditions between the individual cameras of the camera system. These conditions have to be given to the deep learning system in mathematical form, for example a matrix T_{Cam}_{ⱼ}_{→Cam}_{ₖ}, or estimated by the neural network of the deep learning system. The transformation of 3D points between two cameras k, j at time tᵢ can be defined by the equation

Xₜ_{ᵢ}^{cam}^{ₖ}=T_{cam}_{ⱼ}_{→cam}_{ₖ}Xₜ_{ᵢ}^{cam}^{ⱼ}

where Xₜ_{ᵢ}^{Cam}^{ₖ} describes a 3D point in camera k at time tᵢ. Using the extrinsic calibration T_{Cam}_{ⱼ}_{→Cam}_{ₖ}, in this way a 3D point Xₜ_{ᵢ}^{Cam}^{ⱼ} of camera j can be transformed into a 3D point Xₜ_{ᵢ}^{Cam}^{ₖ} of camera k at the same time tᵢ. The respective 3D point Xₜ_{ᵢ}^{Cam}^{ₖ} can be ascertained from the 2D pixel position Xₜ_{ᵢ}^{Cam}^{ₖ} and from the inverse distance dₜ_{ᵢ}^{Cam}^{ₖ} according to the equation

$${X}_{{t}_{i}}^{{cam}_{k}} = \frac{1}{{d}_{{t}_{i}}^{{cam}_{k}}} \cdot {π}_{{cam}_{k}}^{- 1} ( {x}_{{t}_{i}}^{{cam}_{k}} )$$

Here, π_{Cam}_{ₖ}⁻¹ is an inverse projection of the 2D pixel position x onto a 3D sight beam of length 1.

Through the use of the extrinsic calibration in combination with the camera movement Tₜ_{_{i−1}}_{->t}_{ᵢ}^{Cam}^{ₖ}, each 3D point in camera j at time tᵢ₋₁ can be transformed into a 3D point in camera k at time tᵢ. This transformation is consequently described by the equation

Xₜ_{ᵢ}^{cam}^{ₖ}=T_{cam}_{ⱼ}_{→cam}_{ₖ}Tₜ_{_{i−1}}_{→t}_{ᵢ}^{Cam}^{ₖ}Xₜ_{_{i−1}}^{cam}^{ⱼ}.

Through the use of this condition equation, the robustness of the deep learning system can be significantly increased. In the present case, “improved robustness” means that the susceptibility of the system to error can be reduced. For example, a decalibration of an individual camera of the camera system, caused for example by a mechanical misalignment of the optics, can be compensated by the remaining camera or cameras of the camera system, and can also be corrected using this camera or cameras. This also holds for the production of output data that estimate the camera movement of the camera system. Improved robustness also results with regard to failure and sight limitations of individual cameras of the camera system. The improved robustness results given the use of a camera system according to the present invention having at least two cameras, because in this case the fields of view of the at least two cameras can be differently oriented. Moreover, the robustness of the deep learning system is further increased by the method according to the present invention if, in individual cameras, larger image areas are occupied by self-moved objects. In addition, an individual movement of the cameras of the camera system can be calculated from the movement of the camera system as a whole.

Fundamentally, the robustness of the camera system, but also the accuracy of the movement estimation, increases as the number of cameras increases. If the fields of view of at least two cameras overlap at least partially, then it is in addition possible to determine an absolute metric scale.

The method according to an example embodiment of the present invention presented here can be used to train the neural network. Likewise, the method according to an example embodiment of the present invention can be used in the inference if the movement of the camera system is to be estimated using the deep learning system. Due to the self-monitored property of the deep learning system, the possibilities presented here of the geometrical transformation between the individual cameras of the camera system are suitable for calculating a photometric error both in the training and in the inference. In the inference, i.e. in the use of the already-trained neural network, in particular for movement estimation or distance estimation, the determination of the photometric error can however also be omitted.

The method according to an example embodiment of the present invention may be used to ascertain the movement of a camera system having at least two cameras. According to the method, temporally successive individual images, produced by each camera during the movement of the camera system, are provided to a preferably self-monitored deep neural network of a deep learning system as input images. Using these individual images, or input images, the neural network is trained. In the course of the inference, the trained neural network produces output data, which describe the movement of the camera system, from the individual images or input images.

According to a preferred specific embodiment of the present invention, multi-camera conditions between the individual cameras of the camera system are provided to the neural network or are estimated by the neural network. The stated multi-camera conditions can be provided to the deep learning system in mathematical form using the above-described matrix T_{Cam}_{ⱼ}_{→Cam}_{ₖ}.

Preferably, items of distance information, such as an inverse depth or a distance, can be calculated by the neural network for each pixel of the respective individual image from the individual images supplied to the neural network. From this distance information, 3D points can in turn be calculated. The neural network can however also calculate the stated distance information and 3D points in one step. In both variants, the produced 3D points can be transformed into a coordinate system of the camera system, and from this the movement of the camera system can be determined.

According to an advantageous development of the present invention, an optical flux between temporally successive individual images can be calculated from the individual images supplied to the neural network. In this variant, 3D sight beams are calculated from the calculated optical flux. From the calculated 3D sight beams, through triangulation 3D points are produced that are transformed into the coordinate system of the camera system. From the 3D points transformed into the coordinate system of the camera system, the movement of the camera system can then be determined.

According to a further preferred specific embodiment of the present invention, the distance information estimated by the deep learning system, or/and the optical flux, can be used to train the neural network, and can be used in the inference of the trained neural network to determine a photometric error.

According to a further advantageous development of the present invention, in the course of the inference or in the course of the training of the neural network the input images produced by the individual cameras of the camera system can be transformed into a virtual camera that reproduces a model of the environment of the camera system. For the transformation into the virtual camera, the items of depth information provided by the deep learning system per pixel can be used. In this variant, the environmental model is thus applied within the deep learning system. All the outputs of the neural network thus take place not for the individual cameras of the camera system, but rather for the virtual camera defined in this way. If the neural network is to be trained, then the depth and flux information produced for the virtual camera can be transformed by the virtual camera, via corresponding 2D relations, into the relevant individual camera, so that there a photometric error can be calculated. In contrast, for the inference this is not necessary. Rather, in the inference, output data only have to be produced for the virtual camera.

In a variant of the present invention that is an alternative to the development explained above, the output data produced by the deep learning system can be transformed, in the course of a post-processing measure, i.e., outside the deep learning system, into a virtual camera that reproduces a model of the environment of the camera system. For this purpose, the output data produced by the neural network per individual camera and time step for pixels can be transformed into the virtual camera. For this purpose, for each pixel an item of depth information d is required, so that the associated 3D point can be transformed into the coordinate system of the virtual camera KV. From this, through projection of the 3D point into a 2D point, there results the 2D pixel position in the virtual camera.

The present invention further relates to a camera system having a first camera and having at least one second camera, and having a deep learning system connected in data-transmitting fashion to each of the cameras of the camera system. In this way, individual images recorded by the cameras can be transmitted as input images to the deep learning system. The deep learning system has at least one deep, preferably self-monitored, neural network, and is set up/programmed to carry out the method according to the present invention presented above. The advantages explained above of the method according to the present invention are therefore also transferred to the camera system according to the present invention.

Further important features and advantages of the present invention result from the disclosure herein.

Of course, the features named above and explained in the following may be used not only in the respectively indicated combination, but also in other combinations, or by themselves, without departing from the scope of the present invention.

Preferred exemplary embodiments of the present invention are shown in the figures and are explained in more detail in the following description, in which identical reference characters relate to identical or similar or functionally identical components.

### BRIEF DESCRIPTION OF THE DRAWINGS

FIG. 1 schematically shows a flow schema that provides an exemplary illustration of a method according to the present invention.

FIG. 2 shows a variant of the flow schema of FIG. 1, in accordance with the present invention.

### DETAILED DESCRIPTION OF EXAMPLE EMBODIMENTS

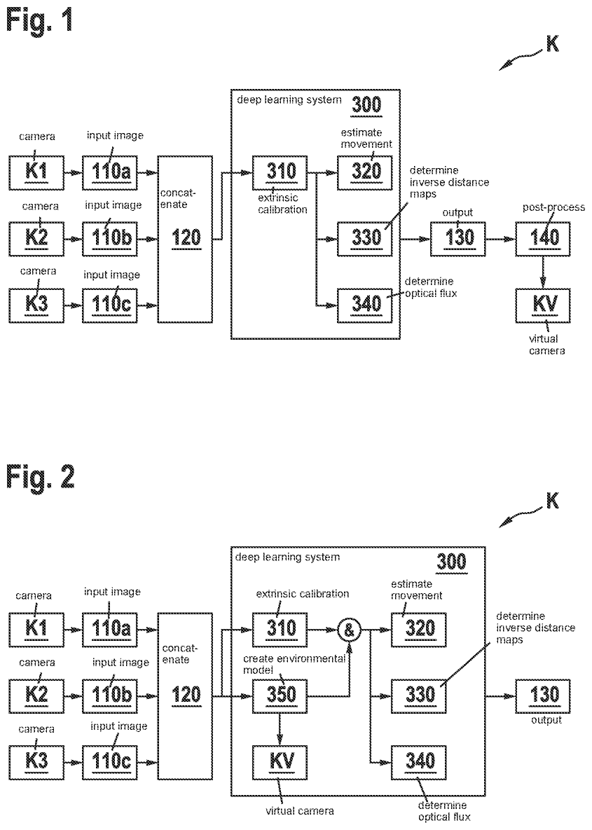

FIG. 1 illustrates, in the manner of a flow diagram, an example of the method according to the present invention. The method according to the present invention is used to ascertain the movement of a camera system K according to the present invention, which in the example of the Figures has three cameras K1, K2, and K3. In addition, camera system K includes a deep learning system 300 that is connected in data-transmitting fashion to cameras K1, K2, and K3. Thus, individual images recorded by each of the cameras K1, K2, and K3 can be transmitted to deep learning system 300. Deep learning system 300 includes at least one self-monitored neural network, for example in the form of a so-called convolutional neural network (CNN). Preferably, the neural network has two or more layers. The neural network can also include a plurality of subnetworks.

During the execution of the method according to the present invention, in particular during a movement of camera system K, each camera K1, K2, K3 produces temporally successive individual images and provides them as input images to the neural network of deep learning system 300 for further processing. Using the input images, the self-monitored neural network can be trained. In the course of the inference, the self-monitored neural network produces, from the input images, output data that describe the movement of camera system K.

In the exemplary flow diagram of FIG. 1, the three cameras K1, K2, K3 produce respective input images 110a, 110b, and 110c. The produced input images 110a, 110b, 110c are first concatenated with one another in an additional measure 120 in order to subsequently provide them to deep learning system 300. During the concatenation, in addition to the input images from the various cameras, images of different time steps t can also be combined.

In deep learning system 300, in the course of an extrinsic calibration 310 geometric relations between the cameras K1-K3 of camera system K are estimated, or are provided directly to deep learning system 300. Such an extrinsic calibration 310 can be provided to deep learning system 300 in the form of the matrix T_{Cam}_{ⱼ}_{→Cam}_{ₖ}. Using the extrinsic calibration 310, the self-monitored network can be trained using the read-in input images 110a, 110b, 110c, or in the course of the inference output data can be produced from the input images 110a, 110b, 110c, which output data characterize the movement Tₜ_{_{i−1}}_{→t}_{ᵢ}^{System} of camera system K and the movement Tₜ_{_{i−1}}_{→t}_{ᵢ}^{Cam}^{ᵢ} of the individual cameras K1-K3. Likewise, from the input images 110a, 110b, 110c supplied to deep learning system 300, deep learning system 300 can calculate items of distance information in the form of distance images, or their inverse dₜ_{ᵢ}^{Cam}^{ₖ}. In addition, from the produced input images 110a, 110b, 110c deep learning system 300 can estimate an optical flux uₜ_{_{i−1}}_{→t}_{ᵢ}^{Cam}^{ₖ} between the temporally successive individual images.

Both in the training and in the inference, the self-monitored neural network of deep learning system 300 can calculate a photometric error between a transformed output image and a target image. The associated geometric transformation towards which a pixel of the output image moves in the target image here results directly from the outputs of deep learning system 300, such as the optical flux or the depth of the associated 3D point and its movement. The transformation takes place in such a way that the photometric error between the transformed output image and the target image becomes as small as possible.

In variants of the example, it is also possible that further application-specific data are estimated by the neural network, for example using semantic instance segmenting.

In order to estimate the movement of camera system K according to measure 320 inside deep learning system 300, at the input side at least two temporally successive images (time steps to and t_{b}) from at least two of the cameras K2-K3 are required. For these at least four camera images, and taking into account the extrinsic calibration that took place in measure 120, the neural network of deep learning system 300 provides, in a measure 330, (inverse) distance maps dₜ_{ₐ}^{Cam}^{ⱼ}, dₜ_{_{b}}^{Cam}^{ⱼ}, dₜ_{ₐ}^{Cam}^{ₖ}, dₜ_{_{b}}^{Cam}^{ₖ}. Using the extrinsic calibration 310, these can then be transformed, according to T_{Cam}_{ⱼ}_{→Cam}_{ₖ}, into the coordinate system X^{System} of camera system K.

The matrix Tₜ_{ₐ}_{→t}_{ᵢ}^{System} which characterizes the sought movement, having six degrees of freedom, of camera system K can be estimated here in measure 320 from the equation

Xₜ_{ₐ}^{System}=Tₜ_{ₐ}_{→t}_{_{b}}^{System}Xₜ_{_{i−1}}_{→t}_{ᵢ}^{System}

and can be outputted as output data by deep learning system 300 in measure 130. Likewise, the ascertained movement T can be used for the training of deep learning system 300. The inverse distance maps d determined in measure 330, and the optical flux u determined in measure 340, can also be used for the training of the neural network, but can also be outputted in measure 130 as output data in the course of the inference.

While the neural network of deep learning system 300 is being trained, the movement of camera system K can be converted into the movement of the individual cameras K1 through K3. Through comparison with the associated inverse distance maps dₜ_{ₐ}^{Cam}^{ⱼ}, dₜ_{_{b}}^{Cam}^{ⱼ}, dₜ_{ₐ}^{Cam}^{ₖ}, dₜ_{_{b}}^{Cam}^{ₖ}, a photometric error can be calculated that the self-monitored neural network can minimize and thereby learn.

In order to determine the matrix Tₜ_{ₐ}_{→t}_{_{b}}^{System} that characterizes the movement of the camera system, it is also possible, as an alternative to the calculation of the inverse distance maps d using the extrinsic calibration according to measure 310, to calculate, in a measure 340 that is alternative to measure 330, the optical flux u between two temporally successive individual images. From the optical flux u, 3D sight beams of length 1 can then be calculated for each camera K1 through K3 and for each time step t. By means of the geometric relations between the individual cameras, calculated through the extrinsic calibration, triangulation can be used to calculate 3D points that, as described above, can be transferred into the coordinate system of camera system K.

The estimation of the movement T according to measure 320, the estimation of the inverses d according to measure 330, and also the estimation of the optical flux u according to measure 340 can be carried out by different subnetworks of the neural network of deep learning system 300. This holds both for the training and in the case of inference.

In a development of the method according to the present invention, in a virtual camera KV a model of the environment of the overall camera system K can be produced, in which model the fields of view of all cameras K1-K3 of camera system K are contained.

Here, all output data can be used that are produced in measure 130 by deep learning system 300 using the method of the present invention, i.e., the movement of camera system K estimated by determining the 4×4 matrix T in measure 320, the inverse distance maps d estimated in measure 330, and the optical flux u estimated in measure 340. Thus, in this variant the production of the environmental model takes place on the basis of the output data provided by deep learning system 300, and thus in a (post-processing) measure 140, which comes after measure 130, outside deep learning system 300.

Usefully, the stated virtual camera KV can be designed such that it includes the fields of view of all cameras K1 through K3 of camera system K. For this purpose, the virtual camera KV can for example be situated centrically between the individual cameras K1-K3 of camera system K, so that a cylinder or a sphere results as the modeled field of view of the virtual camera KV. However, in application-specific fashion, other environmental models or positions of virtual camera KV are also possible in some variants. In all these variants, for each individual camera K1-K3 of camera system K, and for each individual time step t, the information produced by the neural network for each pixel of a respective individual image—in particular the optical flux u and the inverse distance d—is transformed into virtual camera KV. For this purpose, for each pixel the inverse of the distance d is required, so that from this the associated 3D point X can be transformed into the coordinate system of virtual camera KV. 3D point X is calculated as

$${X}_{{t}_{i}}^{{cam}_{j}} = \frac{1}{{d}_{{t}_{i}}^{{cam}_{j}}} \cdot {π}_{{cam}_{j}}^{- 1} ( {x}_{{t}_{i}}^{{cam}_{j}} )$$

and can be transformed into the coordinate system of virtual camera KV by the equation

Xₜ_{ᵢ}^{virt.cam}=T_{cam}_{ⱼ}_{→virt.cam}Xₜ_{ᵢ}^{cam}^{ⱼ}

The resulting 3D points X can be transformed into 2D points x of the virtual camera according to the equation

xₜ_{ᵢ}^{virt.cam}=π_{virt.cam}(Xₜ_{ᵢ}^{virt.cam})

xₜ_{ᵢ}^{cam}^{ₖ}→xₜ_{ᵢ}^{virt.cam}

Via the resulting 2D-2D relation the items of information of the individual cameras K can be transferred into virtual camera KV. In this way, there arises a representation that is comparable to a so-called 360° pseudo-lidar, and enables a compact scene description of cameras K1-K3 of camera system K to a virtual camera KV having a larger field of view.

The environmental model can be produced using virtual camera KV on the basis of the output data provided by deep learning system 300, and thus in a measure 140, which comes after measure 130, outside deep learning system 300.

In a variant, alternative to this, of the method according to the present invention, the creation of the environmental model of camera system K takes place using a virtual camera as shown in FIG. 2—in this case, in contrast, taking place already as measure 350 inside deep learning system 300, coming before measures 320, 330, and 340. In this case, all the outputs of the neural network of the deep learning system 300, i.e. the movement of camera system K characterized by the 4×4 matrix T, inverse distance maps d and optical flux u, also take place inside virtual camera KV. If the neural network is to be trained, then the items of depth and flux information produced for the virtual camera can be transformed by the virtual camera into the relevant individual camera via corresponding 2D-2D relation, so that there a photometric error can be calculated. For the inference, this measure is not required. Rather, in the inference output data can be produced only for the virtual camera.

What is claimed is:

1. A learning-based method for estimating self-movement and distance information in a camera system having at least two cameras using a deep learning system, the method comprising the following steps:
supplying temporally successive individual images produced by each camera during movement of the camera system as input images to a self-monitored deep neural network of a deep learning system; and
training the neural network using the input images; and
in the course of an interference, producing, by the deep learning system, from the input images, output data that describe a movement of the camera system.

2. The method as recited in claim 1, wherein geometric relations between the cameras of the camera system are supplied to the deep learning system for an extrinsic calibration, or are estimated by the neural network of the deep learning system.

3. The method as recited in claim 1, further comprising:
estimating items of distance information from the input images supplied to the deep learning system, and calculating 3D points from the items of distance information; and
transforming the calculated 3D points into a coordinate system of the camera system to estimate the movement of the camera system.

4. The method as recited in claim 1, further comprising:
estimating an optical flux between temporally successive input images from the input images provided to the deep learning system;
producing 3D sight beams from the calculated optical flux;
producing 3D points by triangulation from the 3D sight beams;
transforming the produced 3D points into a coordinate system of the camera system to estimate the movement of the camera system.

5. The method as recited in claim 3, wherein the items of distance information estimated by the deep learning system are used for the training of the neural network, or are outputted by the deep learning system as output data.

6. The method as recited in claim 4, wherein the optical flux estimated by the deep learning system is used for the training of the neural network, or is outputted by the deep learning system as output data.

7. The method as recited in claim 2, wherein using the extrinsic calibration, the deep learning system calculates an individual movement of the each of the cameras of the camera system from the movement of the camera system as a whole.

8. The method as recited in claim 1, wherein:
in the course of the inference or in the course of the training of the neural network, the input images produced by each of the cameras of the camera system are transformed by the deep learning system into a virtual camera that reproduces a model of the environment of the camera system,
for the transformation into the virtual camera, items of depth information provided by the deep learning system per pixel are used.

9. The method as recited in claim 1, wherein outside the deep learning system in a post-processing step, the output data produced by the deep learning system are transformed into a virtual camera that reproduces a model of an environment of the camera system.

10. A movable camera system, comprising:
a first camera and at least one second camera; and
a deep learning system connected in data-transmitting fashion to each of the first camera and the at least one second cameras of the camera system, and including at least one deep self-monitored neural network, the deep learning system configured to receive temporally successive individual images, produced by each of the first camera and the at least one second camera during movement of the camera system, as input images, and to produce from the input images, output data that describe a movement of the camera system.
